(19) United States
(12) Patent Application Publication
(10) Pub. No.: US 2017/0094122 A1
(43) Pub. Date: Mar. 30, 2017

(54) INFORMATION PROCESSING SYSTEM AND IMAGE FORMING APPARATUS

(71) Applicant: Taku IKAWA, Kanagawa (JP)

(72) Inventor: Taku IKAWA, Kanagawa (JP)

(21) Appl. No.: 15/271,820

(22) Filed: Sep. 21, 2016

(30) Foreign Application Priority Data
Sep. 25, 2015 (JP) 2015-188399

(51) Int. Cl. H04N 1/44; H04N 1/32; H04N 1/00

(52) U.S. Cl. CPC H04N 1/4433; H04N 1/00347; H04N 1/32529; H04N 1/4413; H04N 2201/0094; H04N 2201/0039; H04N 2201/3207; H04N 2201/3209

(57) ABSTRACT

An information processing system includes a first image forming apparatus and a second image forming apparatus connected to the first image forming apparatus over a network. The first image forming apparatus includes: a unit configured to transmit a request for a job process to the second image forming apparatus, a unit configured to receive an instruction to perform a job process transmitted from the second image forming apparatus, and a unit configured to perform the job process in accordance with the instruction to perform the job process. The second image forming apparatus includes a unit configured to receive the request for the job process transmitted from the first image forming apparatus, and a unit configured to transmit the instruction to perform the job process pertaining to the received request to the first image forming apparatus.

### CROSS-REFERENCE TO RELATED APPLICATIONS

The present application claims priority under 35 U.S.C. §119 to Japanese Patent Application No. 2015-188399, filed Sep. 25, 2015. The contents of which are incorporated herein by reference in their entirety.

### BACKGROUND OF THE INVENTION

1. Field of the Invention

The present invention relates generally to an information processing system and an image forming apparatus.

2. Description of the Related Art

It is known to connect an image forming apparatus, such as a printer, a copier, a facsimile apparatus, and a MultiFunction Peripheral (MFP) having two or more functions of these apparatuses, to a network and cause the image forming apparatus to conduct user authentication as an information technology (IT) device.

However, having a mass storage, such as a hard disk drive, and a large-capacity program is required of the image forming apparatus to conduct user authentication by itself. This leads to a problem that a compact printer (low-end machine), for which it is difficult to include a mass storage and a large-capacity program, cannot conduct user authentication by itself.

To solve this problem, Japanese Unexamined Patent Application Publication No. 2013-191000 proposes a printing system, in which a low-end machine and an image forming apparatus (high-end machine), such as an MFP, having a hard disk drive are connected over a network, and the high-end machine provides a user authentication function in place of the low-end machine.

However, the above-described conventional printing system is disadvantageous in that the high-end machine cannot be delegated to issue an instruction to perform a job process (e.g., a print process, a copying process, or a scan process) to the low-end machine.

### SUMMARY OF THE INVENTION

According to an aspect of the present invention, there is provided an information processing system including: a first image forming apparatus; and a second image forming apparatus connected to the first image forming apparatus over a network, the first image forming apparatus including a unit configured to transmit a request for a job process to the second image forming apparatus, a unit configured to receive an instruction to perform a job process transmitted from the second image forming apparatus, and a unit configured to perform the job process in accordance with the instruction to perform the job process, and the second image forming apparatus including a unit configured to receive the request for the job process transmitted from the first image forming apparatus, and a unit configured to transmit the instruction to perform the job process pertaining to the received request to the first image forming apparatus.

According to another aspect of the present invention, there is provided an image forming apparatus configured to be connected to another image forming apparatus over a network, the image forming apparatus including: a unit configured to transmit a request for a job process to the another image forming apparatus; a unit configured to receive an instruction to perform a job process transmitted from the another image forming apparatus; and a unit configured to perform the job process in accordance with the instruction to perform the job process.

According to still another aspect of the present invention, there is provided an image forming apparatus configured to be connected to another image forming apparatus over a network, the image forming apparatus including: a unit configured to receive a request for a job process transmitted from the another image forming apparatus; and a unit configured to transmit an instruction to perform a job process pertaining to the received request to the another image forming apparatus.

### BRIEF DESCRIPTION OF THE DRAWINGS

FIG. 1 is a diagram illustrating a system configuration of an information processing system according to an embodiment of the present invention;

FIG. 2 is a sequence diagram illustrating a sequence of processing operations performed in the information processing system according to the embodiment of the present invention in response to entry of login information by a user from a low-end printer;

FIG. 3 is a sequence diagram illustrating a sequence of processing operations performed in the information processing system according to the embodiment of the present invention in response to entry of a print request by the user from the low-end printer;

FIG. 4 is a diagram illustrating a data structure of account information of the information processing system according to the embodiment of the present invention;

FIG. 5 is a diagram illustrating a data structure of history information of the information processing system according to the embodiment of the present invention;

FIG. 6 is a diagram illustrating a data structure of group account information of the information processing system according to the embodiment of the present invention;

FIG. 7 is a sequence diagram illustrating a sequence of processing operations performed in response to entry of a print request by the user from the low-end printer when the information processing system according to the embodiment of the present invention is performing management based on the group account information;

FIG. 8 is a sequence diagram illustrating a sequence of processing operations performed in response to a user's operation, which is performed from the low-end printer, of installing an application in the information processing system according to the embodiment of the present invention;

FIG. 9 is a diagram illustrating license information for an application in the information processing system according to the embodiment of the present invention; and

FIG. 10 is a sequence diagram illustrating a sequence of processing operations for running a series of jobs across two low-end printers in the information processing system according to the embodiment of the present invention.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, an and the are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

The present invention has an object to provide an information processing system and an image forming apparatus that allows a high-end machine to be delegated to issue an instruction to perform a job process to the low-end machine.

Configuration of Information Processing System

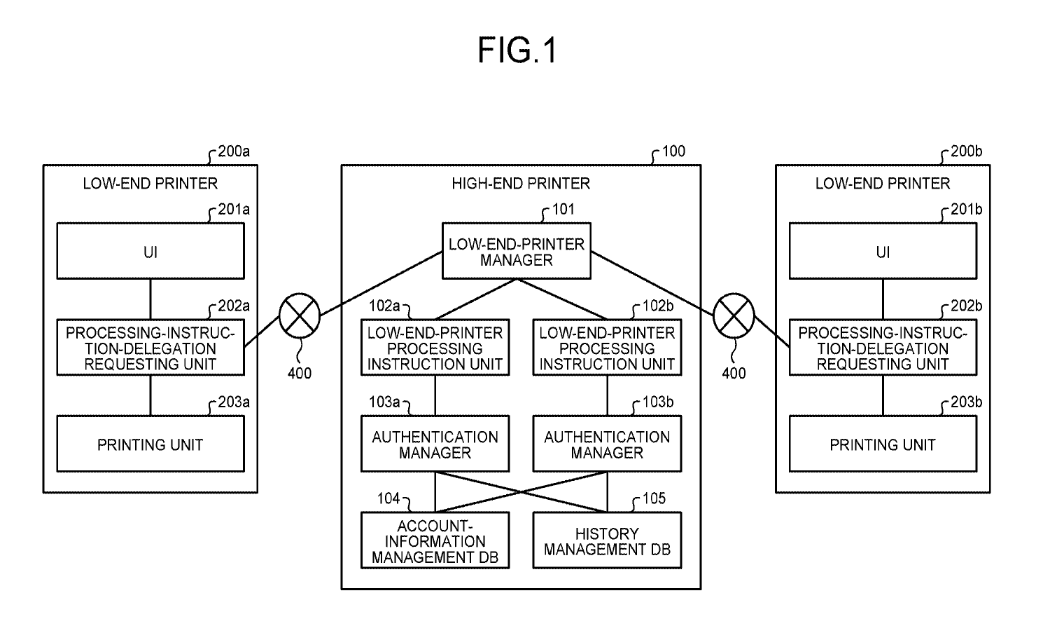

FIG. 1 is a diagram illustrating a system configuration of an information processing system according to an embodiment of the present invention.

The information processing system according to the embodiments of is configured such that a high-end printer 100 and low-end printers 200a and 200b are communicably connected over a network 400, such as a LAN (Local Area Network). The numbers of the high-end printers and the low-end printers connected over the network 400 are not limited to those of the embodiment.

The low-end printer 200a and the low-end printer 200b, each is an example of “first image forming apparatus”, transmits a user's request (a login request, a job process request) to the high-end printer 100, which is an example of “second image forming apparatus”. Furthermore, the low-end printer 200a, 200b requests the high-end printer 100 to issue an instruction to cause the low-end printer 200a, 200b to perform a job process in place of the low-end printer 200a, 200b.

The low-end printer 200a is identical in configuration with the low-end printer 200b. Specifically, a UI (user interface) 201a, a processing-instruction-delegation requesting unit 202a, and a printing unit 203a included in the low-end printer 200a are identical with a UI 201b, a processing-instruction-delegation requesting unit 202b, and a printing unit 203b included in the low-end printer 200b, respectively. Hereinafter, unless otherwise it is necessary to differentiate the low-end printers 200a and 200b, each is referred to as the low-end printer 200. Similarly, their internal blocks are referred to as follows: each of the UIs 201a and 201b is referred to as the UI 201; each of the processing-instruction-delegation requesting units 202a and 202b is referred to as the processing-instruction-delegation requesting unit 202; and each of the printing units 203a and 203b is referred to as the printing unit 203. The UI 201 and the processing-instruction-delegation requesting unit 202 are implemented by a CPU, which is hardware included in the low-end printer 200, by executing computer-executable instructions.

The UI 201 has a function of accepting a user's input entered from a display unit, such as a liquid crystal display, or an operating unit, such as various keys. The processing-instruction-delegation requesting unit 202 has a function of sending a notification of (i.e., transmitting) a user's request (a login request, a job process request) to the high-end printer 100, a function of accepting (i.e., receiving) an instruction to perform a job process from the high-end printer 100, and a function of transmitting an instruction to perform a job process to a function performing unit of the low-end printer 200, to which the processing-instruction-delegation requesting unit 202 belongs. The printing unit 203 has a function of performing a print process in accordance with an instruction to perform the print process.

The high-end printer 100 accepts a user's job process request transmitted from the low-end printer 200, determines whether or not the job process request from the low-end printer 200 may be performed, issues an instruction to perform the job process, and records the job process.

The high-end printer 100 includes a low-end-printer manager 101, low-end-printer processing instruction units 102a and 102b, authentication managers 103a and 103b, an account-information management DB (database) 104, and a history management DB 105. These are implemented by the CPU, which is the hardware included in the high-end printer 100, by executing computer-executable instructions.

The low-end-printer manager 101 has a function of storing records of and managing a plurality of (in the illustrated example, two) low-end-printer processing instruction units (in this example, the two low-end-printer processing instruction units (102a and 102b)) included in the low-end-printer manager 101. The low-end-printer manager 101 further has a function of accepting a user's request from the low-end printer 200, determining to which one of the plurality of low-end-printer processing instruction units included in the low-end-printer manager 101 a processing instruction is to be transmitted, and transmitting the user's request to the determined low-end-printer processing instruction unit.

The two low-end-printer processing instruction units (102a and 102b) correspond to the low-end printers 200a and 200b, respectively, and are identical in configuration and function. The authentication managers 103a and 103b also correspond to the low-end printers 200a and 200b, respectively, and are identical in configuration and function. Hereinafter, unless otherwise it is necessary to differentiate the low-end-printer processing instruction units 102a and 102b, each is referred to as the low-end-printer processing instruction units 102; similarly, each of the authentication managers 103a and 103b is referred to as the authentication manager 103.

The number of the low-end-printer processing instruction units 102 is equal to the number of the low-end printers 200 to be managed. The low-end-printer processing instruction unit 102 has the following functions:

accepting, at login, a login request from the low-end-printer manager 101 and requesting the authentication manager 103 to perform an authentication process; accepting a job process request from the low-end-printer manager 101 and requesting the authentication manager 103 related to the low-end-printer processing instruction unit 102 to determine whether or not the requested job process may be performed; and issuing an instruction, to the low-end-printer manager 101, to perform the job process to be performed on the low-end printer 200.

The number of the authentication managers 103 is equal to the number of the low-end printers 200 to be managed. The authentication manager 103 has the following functions:

performing, at login, an authentication process using login information transmitted from the low-end-printer processing instruction unit 102 and transmitting a result of the authentication to the low-end-printer processing instruction unit 102;

managing accounts logged in to the low-end printers 200 (note that this function involves recording the logged-in accounts);

at printing, obtaining a logged-in account of the low-end printer 200, to which a print request is issued, verifying the authority of the logged-in account to perform printing (right to use the job process function) (note that this process of verifying the authority to perform printing corresponds to “determination as to whether or not the process may be performed”), and issuing a print request to the low-end-printer processing instruction unit 102; and

recording print history in the history management DB 105.

The account-information management DB 104 has a function of managing account information. Details of the account information will be described later. The history management DB 105 has a function of managing processing history information. Details of the history information will be described later.

Login Process

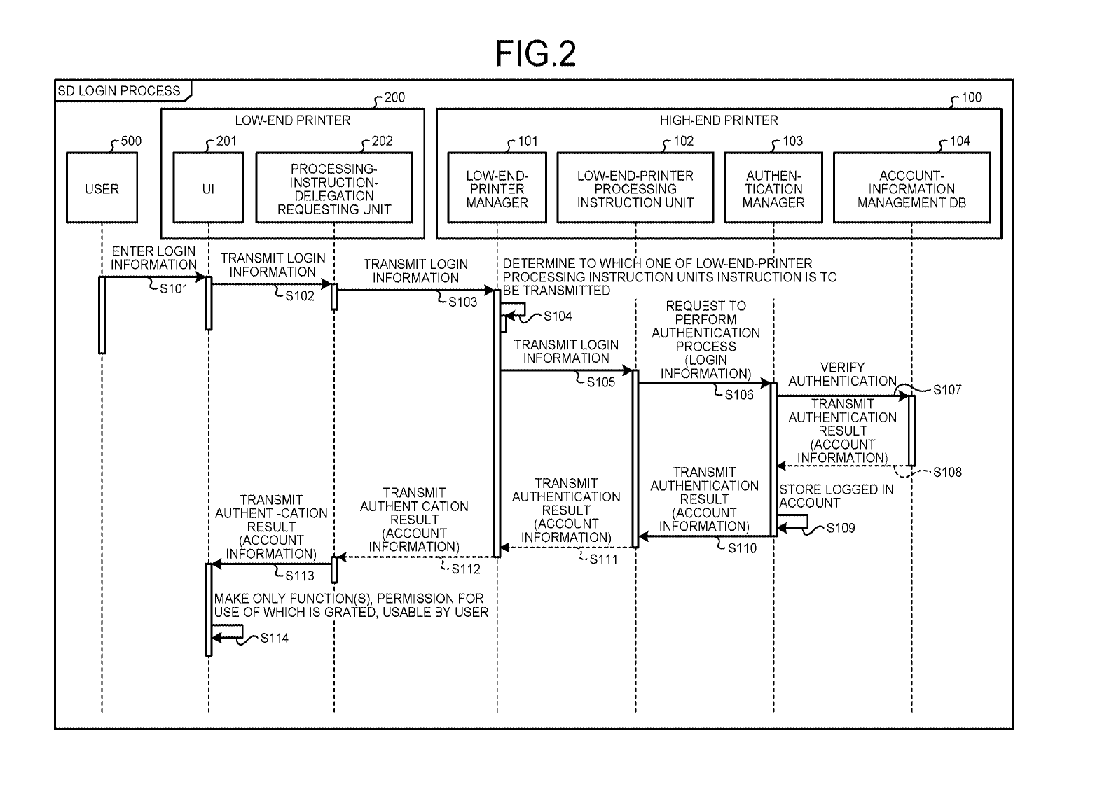

FIG. 2 is a sequence diagram illustrating a sequence of processing operations performed in the information processing system according to the embodiment of the present invention in response to entry of login information by a user from a low-end printer. A logged-in-account management function, an account authentication function, and a function of limiting available functions on an account-by-account basis are described below with reference to this sequence diagram.

When login information is entered by a user 500 to the low-end printer 200 using the UI 201 (Step S101), the UI 201 transmits the login information to the processing-instruction-delegation requesting unit 202 (Step S102). The processing-instruction-delegation requesting unit 202 transmits the login information to the high-end printer 100 by specifying a corresponding URL (Uniform Resource Locator), which is stored in advance, of the high-end printer 100 (Step S103).

In the high-end printer 100, the low-end-printer manager 101 accepts all requests from the low-end printer 200. Upon receiving the login information from the low-end printer 200, the low-end-printer manager 101 determines to which one of the plurality of low-end-printer processing instruction units 102 included in the low-end-printer manager 101 a processing instruction is to be transmitted (Step S104), and transmits the login information to the determined low-end-printer processing instruction unit 102 (Step S105).

Upon receiving the login information, the low-end-printer processing instruction unit 102 transmits the login information to the authentication manager 103 and requests the authentication manager 103 to conduct authentication (Step S106). Upon being requested to conduct authentication, the authentication manager 103 determines whether or not to permit login by checking transmitted account information against the account information stored in the account-information management DB 104 (Steps S107 to S109).

If the authentication manager 103 determines to permit log in (i.e., the authentication is “success”), the authentication manager 103 transmits this authentication result and the account information to the low-end-printer processing instruction unit 102 (Step S110). If the authentication manager 103 determines not to permit log in (i.e., the authentication is “failure”), the authentication manager 103 notifies the low-end-printer processing instruction unit 102 that the login attempt has failed.

Upon receiving the authentication result “success” and the account information, the low-end-printer processing instruction unit 102 transmits them to the low-end-printer manager 101 (Step S111). The low-end-printer manager 101 transmits the authentication result “success” and the account information to the low-end printer 200 by specifying a corresponding URL, which is stored in advance, of the low-end printer 200 (Step S112).

Upon receiving the authentication result “success” and the account information, the low-end printer 200 transmits the authentication result “success” to the UI 201 (Step S113). The UI 201 notifies the user 500 of the authentication result “success”. The UI 201 makes only a function(s), permission for use of which is grated to the user 500, usable by the user 500 based on available-function limiting information contained in the account information (Step S114).

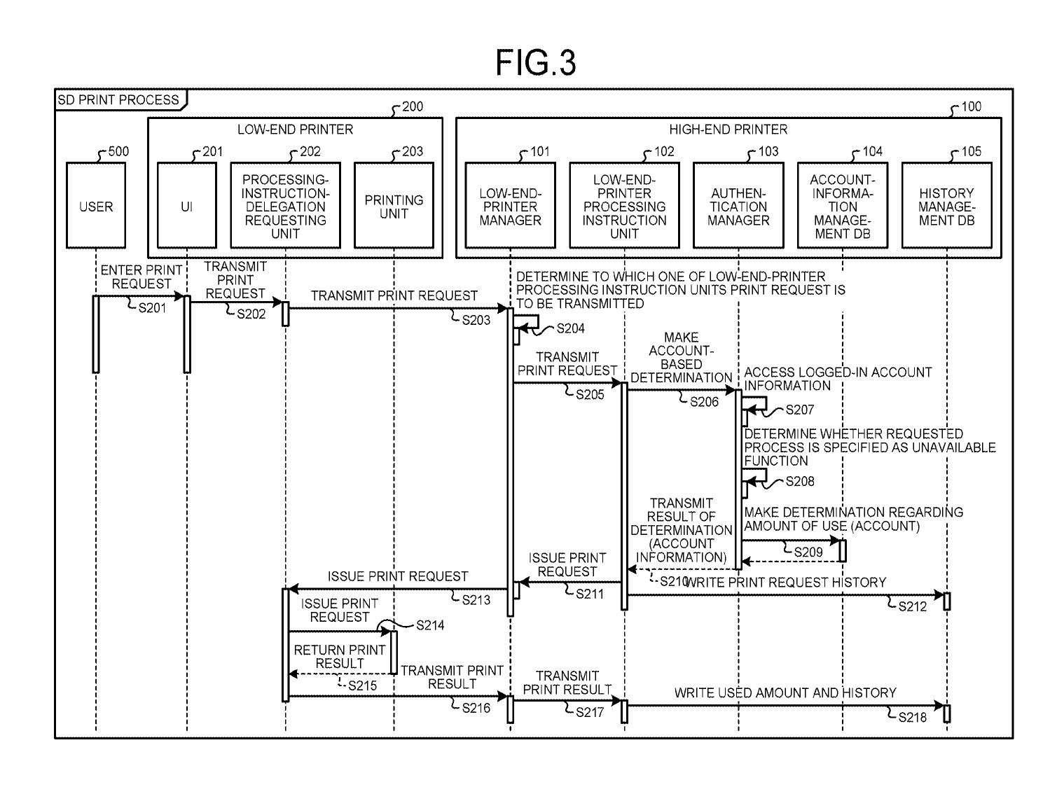

Print Process FIG. 3 is a sequence diagram illustrating a sequence of processing operations performed in the information processing system according to the embodiment of the present invention in response to entry of a print request by the user from the low-end printer. Amounts of use, a usage-history managing function, and a function of utilizing fees in billing management on an account-by-account basis are described below with reference to FIG. 13.

When a print request is entered as a job process request by the user 500 using the UI 201 of the low-end printer 200 (Step S201), the UI 201 transmits the print request to the high-end printer 100 via the processing-instruction-delegation requesting unit 202 (Steps S202 and S203).

In the high-end printer 100, the print request, which is received by the low-end-printer manager 101, is transmitted to the low-end-printer processing instruction unit 102 (Steps S204 and S205). Specifically, the low-end-printer manager 101 determines to which one of the plurality of low-end-printer processing instruction units 102 included in the low-end-printer manager 101 the print request is to be transmitted (Step S204), and transmits the print request to the determined low-end-printer processing instruction unit 102 (Step S205).

The low-end-printer processing instruction unit 102 requests the authentication manager 103 to determine whether or not the requested process (the print process) may be performed (Step S206: account-based determination). The authentication manager 103 accesses logged-in account information managed by the authentication manager 103 itself (Step S207), and determines whether or not the requested process (the print process) is specified as a function unavailable to the account and whether or not the function is unavailable because the amount of use of the function (i.e., the amount of use of the printing function) has reached its upper limit (Steps S208 and S209). If the requested process is not specified as unavailable, the authentication manager 103 transmits this result (printing may be performed) and the account information to the low-end-printing processing instruction unit 102 (Step S210).

Upon receiving the authentication result that printing may be performed, the low-end-printing processing instruction unit 102 issues a print request (instruction to perform printing) to the low-end printer 200 via the low-end-printer manager 101 (Steps S211 and S213) and writes print request history in the history management DB 105 (Step S212).

In the low-end printer 200, upon receiving the print request, the processing-instruction-delegation requesting unit 202 issues a print request to the printing unit 203 (Step S214). The printing unit 203 performs printing and returns a result of the printing to the processing-instruction-delegation requesting unit 202 (Step S215). The processing-instruction-delegation requesting unit 202 transmits the print result to the high-end printer 100 (Step S216).

In the high-end printer 100, the low-end-printer manager 101 receives the print result and transmits the print result to the low-end-printer processing instruction unit 102 (Step S217). The low-end-printing processing instruction unit 102 writes the print result (i.e., the result of performing the print process) as history information in the history management DB (Step S218).

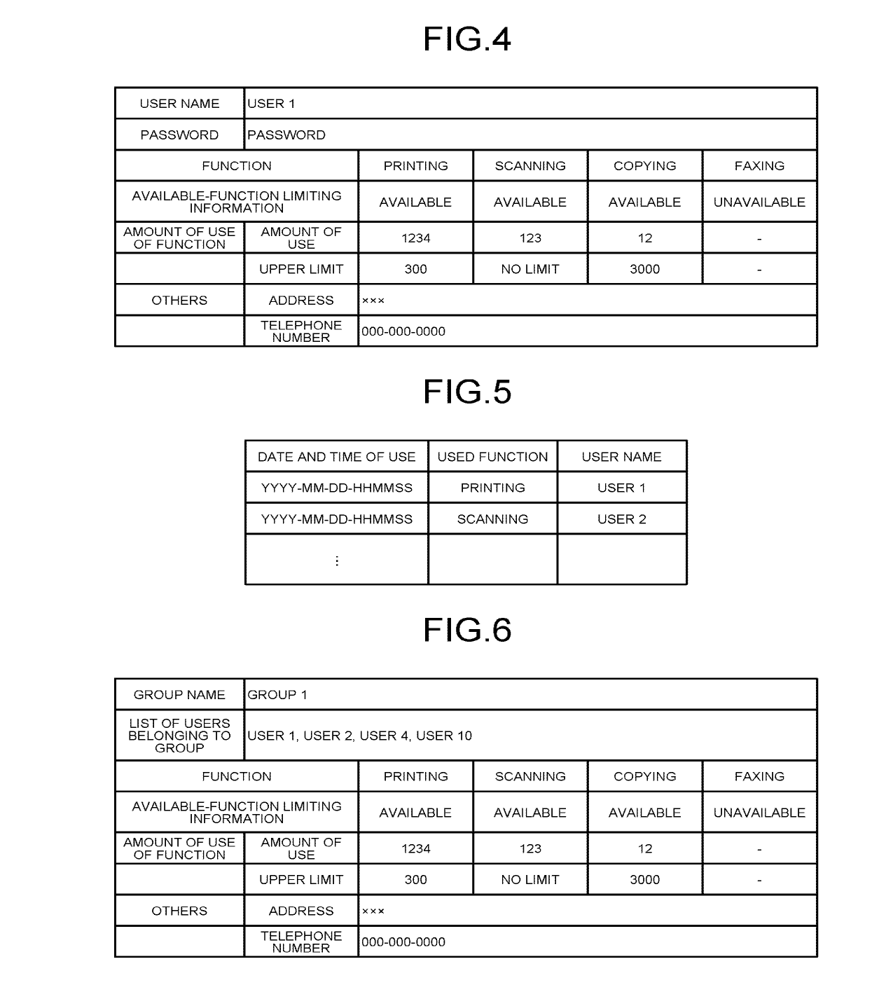

Data Structure of Account Information FIG. 4 is a diagram illustrating a data structure of account information of the information processing system according to the embodiment of the present invention. The account information is stored in the account-information management DB 104.

As illustrated in FIG. 4, the account information contains, for each of accounts, a user name, a password, available-function limiting information, amounts of use of functions, and other information (in FIG. 4, address and a telephone number). The available-function limiting information for User 1 presented in FIG. 4 indicates that User 1 can perform (“AVAILABLE”) printing, scanning, and copying, but cannot perform (“UNAVAILABLE”) faxing. The amounts of use of functions are as follows: the amount of use and its upper limit of the printing function are 1234 and 3000, respectively; the amount of use and its upper limit of the scanning function are 123 and no limit, respectively; and the amount of use and its upper limit of the copying function are 12 and 3000, respectively.

Data Structure of History Information

FIG. 5 is a diagram illustrating a data structure of history information of the information processing system according to the embodiment of the present invention. The history information is stored in the history management DB 105. As illustrated in FIG. 5, the history information contains date and time of use (year, month, day, hour, minute, and second), used functions, and user names.

Data Structure of Group Account Information

In the information processing system according to the embodiment of the present invention, the high-end printer 100 is capable of grouping management of the plurality of low-end printers 200 and limiting (specifying) available functions on a group-by-group basis.

FIG. 6 is a diagram illustrating a data structure of group account information implementing limiting available functions on a group-by-group basis. As illustrated in FIG. 6, the group account information contains, for each of groups, a list of users belonging to the group, available-function limiting information, amounts of use of functions, and other account information.

Referring to FIG. 6, User 1, User 2, User 4, and User 10 belong to Group 1. The available-function limiting information for Group 1 indicates that Group 1 can perform (“AVAILABLE”) printing, scanning, and copying, but cannot perform (“UNAVAILABLE”) faxing. The amounts of use of functions are as follows: the amount of use and its upper limit of the printing function are 1234 and 3000, respectively; the amount of use and its upper limit of the scanning function are 123 and no limit, respectively; and the amount of use and its upper limit of the copying function are 12 and 3000, respectively.

Print Process with Management Based on Group Account Information

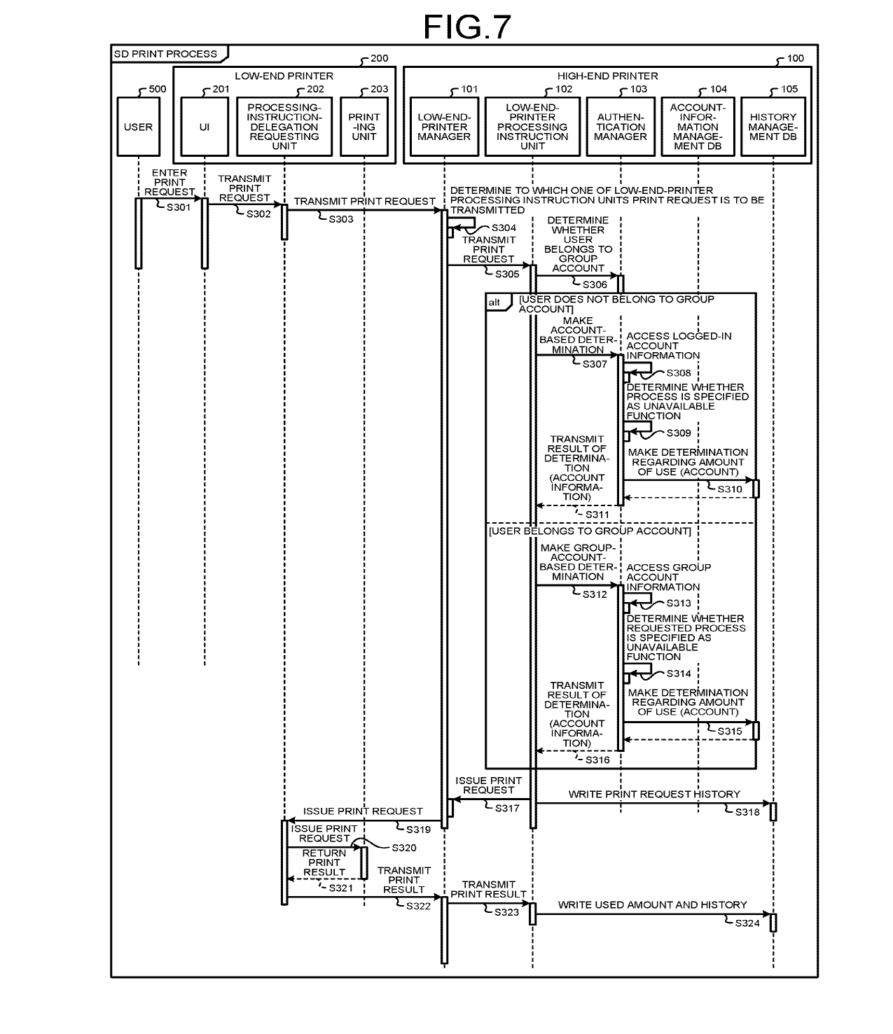

FIG. 7 is a sequence diagram illustrating a sequence of processing operations performed in response to entry of a print request by the user from the low-end printer when the information processing system according to the embodiment of the present invention is performing management based on the group account information. Amounts of use, a usage-history managing function, and a function of utilizing fees in billing management on a group-account-by-group-account basis are described below with reference to FIG. 7.

Steps S301 to S305 of FIG. 7 are identical to Steps S201 to S205 of FIG. 3, and repeated description is omitted.

At the next step S306, the low-end-printer processing instruction unit 102 requests the authentication manager 103 to determine whether or not the requested process (the print process) may be performed. Specifically, the low-end-printing processing instruction unit 102 determines, on the basis of the data structure of the group account (FIG. 6), whether or not the user 500 that has issued the print request belongs to the group account (the list of users belonging to the group). If the user 500 does not belong to the group account, the low-end-printing processing instruction unit 102 requests the authentication manager 103 to make the determination by specifying personal account information (Step S307). If the user 500 belongs to the group account, the low-end-printing processing instruction unit 102 requests the authentication manager 103 to make the determination by specifying the group account (Step S312).

Steps S307 to S311, which are processing operations for the case where the user 500 does not belong to the group account, are identical to Steps S206 to S210 of FIG. 3. Specifically, the authentication manager 103 accesses the logged-in account information (personal account information, an example of which is presented in FIG. 4) managed by the authentication manager 103 itself, and determines whether or not the requested process (the print process) is specified as a function unavailable to the account and whether or not the function is unavailable because the amount of use of the function (i.e., the amount of use of the printing function) has reached its upper limit. If the process is not specified as unavailable, the authentication manager 103 transmits this result and the account information to the low-end-printer processing instruction unit 102.

Steps S312 to S316, which are processing operations for the case where the user 500 belongs to the group account, differ from Steps S307 to S311, which are the processing operations for the case where the user 500 does not belong to the group account, in accessing the group account information (FIG. 6) in lieu of the personal account information.

Specifically, the authentication manager 103 accesses the group account information managed by the authentication manager 103 itself, and determines whether or not the requested process (the print process) is specified as a function unavailable to the group account and whether or not the function is unavailable because the amount of use of the function (i.e., the amount of use of the printing function) has reached its upper limit. If the process is not specified as unavailable, the authentication manager 103 transmits this result and the group account information to the low-end-printer processing instruction unit 102.

Steps S317 to S324 performed subsequent to Step S311 are identical to Steps S211 to S218 of FIG. 3. Steps S317 to S324 performed subsequent to Step S316 are identical to Steps S211 to S218 of FIG. 3 except that history of the group account is written at Step S318 and Step S324.

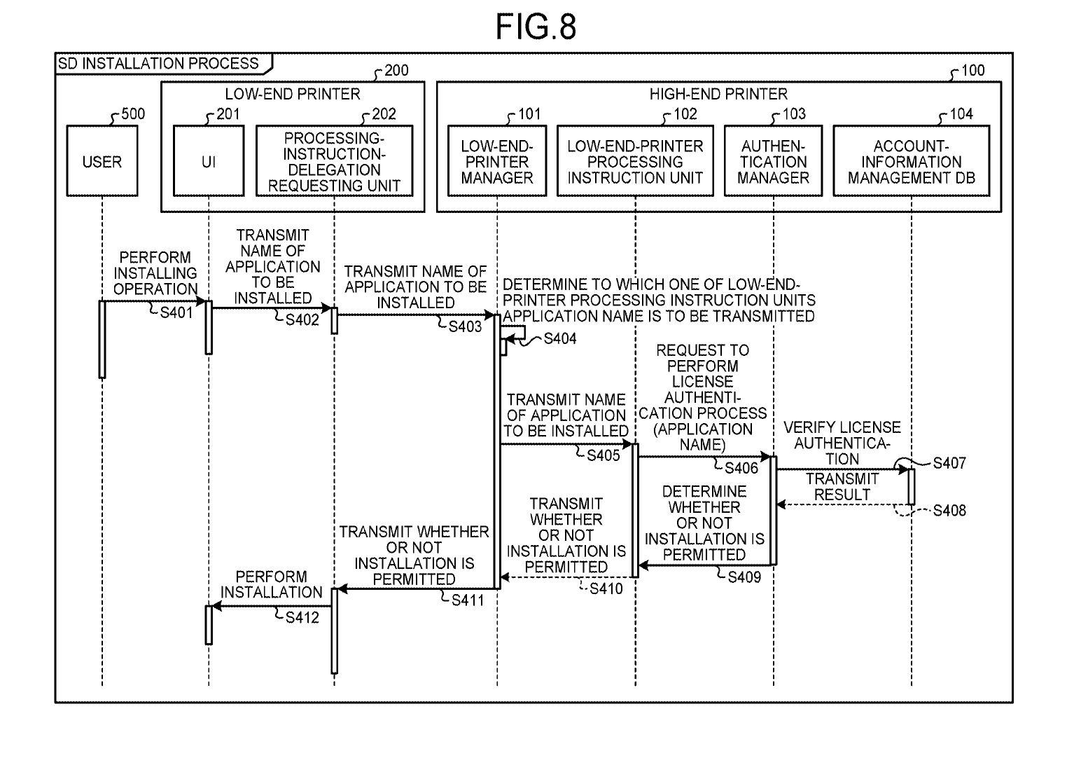

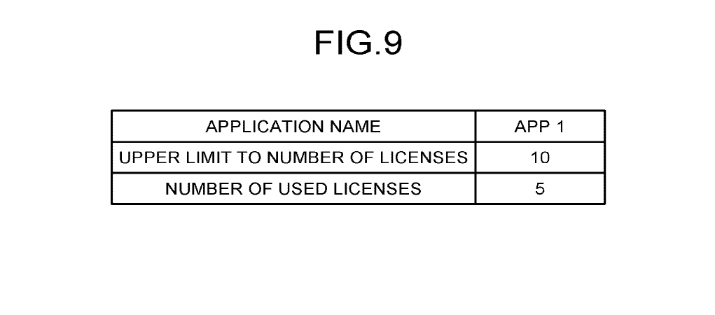

FIG. 8 is a sequence diagram illustrating a sequence of processing operations in response to a user's operation, which is performed from the low-end printer, of installing an application in the information processing system according to the embodiment of the present invention. FIG. 9 is a diagram illustrating license information for an application.

As a usage scenario where the processing operations illustrated in FIG. 8 are performed, for example, a scenario, in which an application is installed from an SD card, is assumed. It is also assumed that the installation is performed in an environment where the low-end printer 200 is not connected to an application management server or the like, and only the low-end printer 200 and the high-end printer 100 are network-connected in a local environment.

When an operation of installing an application is performed by the user 500 using the UI 201 (Step S401), the low-end printer 200 transmits name of the application to be installed to the high-end printer 100 (Steps S402 and S403).

Upon receiving the application name from the low-end printer 200, the low-end-printer manager 101 determines to which one of the plurality of low-end-printer processing instruction units 102 included in the low-end-printer manager 101 the application name is to be transmitted (Step S404), and transmits the application name to the determined low-end-printer processing instruction unit 102 (Step S405).

Upon receiving the application name, the low-end-printer processing instruction unit 102 transmits the application name to the authentication manager 103 and requests the authentication manager 103 to perform a license authentication process (Step S406).

License information, an example of which is illustrated in FIG. 9, is stored in the account-information management DB 104 of the high-end printer 100. The authentication manager 103 manages licenses based on the license information.

The authentication manager 103 validates license authentication of the application of the transmitted application name against the account-information management DB 104 (Step S407) and determines, based on the result of the validation, whether or not the number of used licenses for the application that is to be installed on the low-end printer 200 has reached an upper limit of the number of licenses (Steps S408 and S409). If the number of the used licenses has not reached the upper limit, the authentication manager 103 determines that installation is permitted and notifies the low-end printer 200 of this result (Steps S410 and S411). Upon receiving this result, the low-end printer 200 performs installation (Step S412).

It is preferable that the account-information management DB 104 of the high-end printer 100 operates in synchronization with an application server or the like to enable integrated management of account information even when a plurality of the high-end printers 100 are included in the information processing system.

Running a Series of Jobs Across Two Low-End Printing Apparatuses

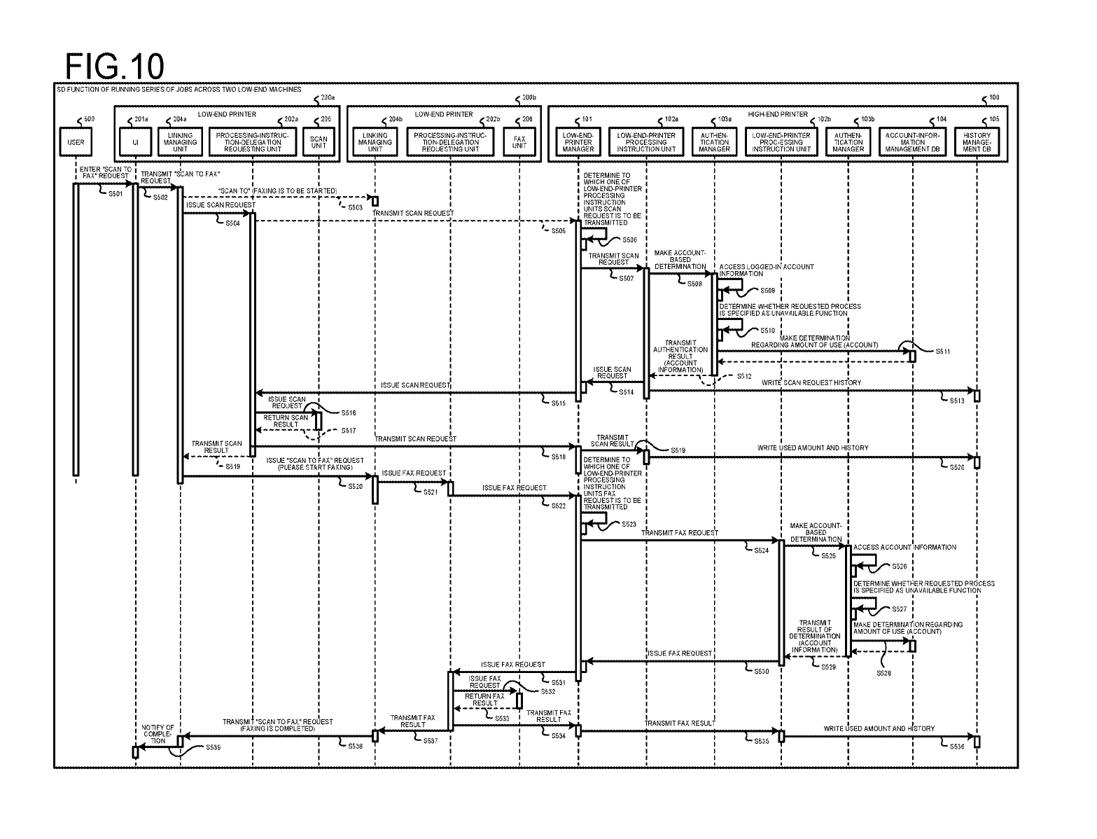

FIG. 10 is a sequence diagram illustrating a sequence of processing operations for running a series of jobs across the two low-end printers in the information processing system according to the embodiment of the present invention. A sequence for controlling use of “Scan to Fax” functions as functions of a series of jobs run across a plurality of machines (hereinafter, “functions of linked jobs”) is described below.

In FIG. 10, the low-end printer 200a is a device (corresponding to “first image forming apparatus”) that accepts a user's request and performs scanning of the linked jobs; the low-end printer 200b is a device (corresponding to “third image forming apparatus”) that performs faxing of the linked jobs.

When a request for “Scan to Fax” from the user 500 is accepted by the UI 201 of the low-end printer 200a (Steps S501 and S502), a linking managing unit 204a of the low-end printer 200a notifies a linking managing unit 204b of the low-end printer 200b that the linked jobs are to be started (Step S503).

In the low-end printer 200a, the linking managing unit 204a issues a scan request to the processing-instruction-delegation requesting unit 202a (Step S504). The sequence of a scan process (from Steps S505 “issue scan request” to Step S519 “transmit scan result”) subsequent to Step S504 is similar to the sequence (from Step S203 “transmit print request” to Step S217 “transmit print result”) of FIG. 3. Hence, determination as to whether or not the function is specified as unavailable is made for the scanning function singly.

When the scan is completed, the linking managing unit 204a of the low-end printer 200a issues a “Scan to Fax” request to the linking managing unit 204b of the low-end printer 200b (Step S520). Upon receiving a fax request, the processing-instruction-delegation requesting unit 202 issues a fax request to the processing-instruction-delegation requesting unit 202b (Step S521). The sequence of a fax process (from Steps S522 “issue fax request” to Step S537 “transmit fax result”) that follows Step S521 is similar to the sequence (from Step S203 “transmit print request” to Step S217 “transmit print result”) of FIG. 3. Hence, determination as to whether or not the function is specified as unavailable is made for the faxing function singly.

Upon receiving a result of the faxing at Step S537, the linking managing unit 204b of the low-end printer 200b notifies the linking managing unit 204a of the low-end printer 200a that the “Scan to Fax” request is completed (Step S538). The linking managing unit 204a notifies the user 500 that “Scan to Fax” is completed using the UI 201a (Step S539).

As described above in detail, the information processing system according to the embodiment of the present invention is characterized by (1) to (4) below.

(1) The high-end printer 100 holds information about a user logged in to the low-end printers 200. The high-end printer 100 makes determination as to whether or not a job process may be performed (determination as to whether or not the process may be performed) in accordance with authority granted to the logged-in user, and issues an instruction to perform the job process to the low-end printers 200. Accordingly, the high-end printer 100 is capable of not only conducting user authentication but also being delegated to issue an instruction to perform a job process to the low-end printers 200.

(2) The high-end printer 100 can manage logged-in accounts of the plurality of low-end printers 200, perform grouping management of the low-end printers 200, and limit (specify) available functions on a group-by-group basis.

(3) The high-end printer 100 can conduct license authentication in place of the low-end printer 200 at installation of an application to the low-end printer 200.

(4) When a series of processes (linked jobs) are to be run across two low-end machines or across the low-end printer 200 and the high-end printer 100, it is possible to limit (specify) available functions for the linked job functions.

According to an aspect of the present embodiments, when a first image forming apparatus is assigned as a high-end machine and a second image forming apparatus is assigned as a low-end machine, the high-end machine can be delegated to issue an instruction to perform a job process to the low end machine.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing system comprising:
a first image forming apparatus; and
a second image forming apparatus connected to the first image forming apparatus over a network,
the first image forming apparatus including
a unit configured to transmit a request for a job process to the second image forming apparatus,
a unit configured to receive an instruction to perform a job process transmitted from the second image forming apparatus, and
a unit configured to perform the job process in accordance with the instruction to perform the job process, and
the second image forming apparatus including
a unit configured to receive the request for the job process transmitted from the first image forming apparatus, and
a unit configured to transmit the instruction to perform the job process pertaining to the received request to the first image forming apparatus.

2. The information processing system according to claim 1, wherein
the first image forming apparatus includes
a unit configured to transmit account information to the second image forming apparatus, and
a unit configured to receive a result of authentication of the account information transmitted from the second image forming apparatus, and
the second image forming apparatus includes
a unit configured to receive the account information transmitted from the first image forming apparatus,
a unit configured to authenticate the received account information, and
a unit configured to transmit the result of the authentication to the first image forming apparatus.

3. The information processing system according to claim 2, wherein the result of the authentication of the account information contains available-function limiting information, the available-function limiting information being information limiting available functions of the first image forming apparatus.

4. The information processing system according to claim 3, wherein the second image forming apparatus transmits the instruction to perform the job process when the job process pertaining to the received request is not specified as unavailable by the available-function limiting information.

5. The information processing system according to claim 1, wherein the second image forming apparatus includes a unit configured to store history of the instruction to perform the job process.

6. The information processing system according to claim 1, wherein
the first image forming apparatus includes a unit configured to transmit a result of performing the job process, the job process having been performed in accordance with the instruction to perform the job process, to the second image forming apparatus, and
the second image forming apparatus includes
a unit configured to receive the result of performing the job process, and
a unit configured to store history of the received result of performing the job process.

7. The information processing system according to claim 2, wherein the second image forming apparatus includes a unit configured to perform grouping management of account information of a plurality of the first image forming apparatuses.

8. The information processing system according to claim 1, wherein the second image forming apparatus includes a unit configured to manage license information for an application to be installed on the first image forming apparatus.

9. The information processing system according to claim 1, further comprising a third image forming apparatus, wherein
the first image forming apparatus includes a unit configured to issue a request for a job process to the third image forming apparatus,
the third image forming apparatus includes
a unit configured to receive the request for the job process transmitted from the first image forming apparatus,
a unit configured to transmit the received request to the second image forming apparatus,
a unit configured to receive an instruction to perform a job process transmitted from the second image forming apparatus,
a unit configured to perform the job process in accordance with the received instruction to perform the job process, and
a unit configured to transmit a result of performing the job process to the first image forming apparatus, and
the second image forming apparatus includes
a unit configured to receive the request for the job process transmitted from the third image forming apparatus, and
a unit configured to transmit the instruction to perform the job process pertaining to the received request to the third image forming apparatus.

10. An image forming apparatus configured to be connected to another image forming apparatus over a network, the image forming apparatus comprising:
a unit configured to transmit a request for a job process to the another image forming apparatus;
a unit configured to receive an instruction to perform a job process transmitted from the another image forming apparatus; and
a unit configured to perform the job process in accordance with the instruction to perform the job process.

11. An image forming apparatus configured to be connected to another image forming apparatus over a network, the image forming apparatus comprising:
a unit configured to receive a request for a job process transmitted from the another image forming apparatus; and
a unit configured to transmit an instruction to perform a job process pertaining to the received request to the another image forming apparatus.
